(19) United States
(12) Patent Application Publication
(10) Pub. No.: US 2026/0196635 A1
(43) Pub. Date: Jul. 9, 2026

(54) POWER SOURCE RETENTION SYSTEM

(71) Applicant: OCADO INNOVATION LIMITED, Hatfield, Hertfordshire (GB)

(72) Inventors: Christopher STAREY, Hatfield, Hertfordshire (GB); Christopher TRACEY, Hatfield, Hertfordshire (GB); Anthony OGWARA, Hatfield, Hertfordshire (GB)

(73) Assignee: OCADO INNOVATION LIMITED, Hatfield, Hertfordshire (GB)

(21) Appl. No.: 18/868,440

(22) PCT Filed: May 22, 2023
(86) PCT No.: PCT/EP2023/063608

§ 371 Date: Nov. 22, 2024

(30) Foreign Application Priority Data
May 23, 2022 (GB) 2207553.5

(51) Int. Cl. H01M 50/264; B60L 53/80; H01M 50/249

(52) U.S. Cl. CPC H01M 50/264; B60L 53/80; H01M 50/249; B60L 2200/40; H01M 2220/20

(57) ABSTRACT

A power source retention system including a power source having an outer casing and a locking member mounted on top of the outer casing for rotation about a vertical axis relative to the outer casing. A power source compartment is configured to removably receive the power source into a power-source-receiving space in a vertical direction. A retention member is located adjacent to the power-source-receiving space. The locking member is rotatable about the vertical axis in a locking direction. The locking member engages the retention member to block the power source from being upwardly removed from the power source compartment, and is rotatable in an opposite, unlocking direction about the vertical axis whereby the locking member is unengaged from the retention member to allow the power source to be upwardly removed from the power source compartment.

### TECHNICAL FIELD

The present invention relates to a power source retention system for securely holding a power source in a power source compartment.

### BACKGROUND

Some commercial and industrial activities require systems that enable the storage and retrieval of a large number of different products. WO2015019055A1 describes a storage and retrieval system in which stacks of storage containers are arranged within a grid storage structure. The system further comprises remotely operated load handling devices configured to move on tracks located on the top of the grid storage structure. To access the containers in the grid storage structure, the load handling devices are equipped with a container-holding device for releasably gripping a container at the top of a stack and a lifting mechanism for raising and lowering the container.

Each load handling device is powered by a rechargeable battery. The rechargeable battery is typically charged in situ by driving a load handling device to a charging station located at the edge of the grid storage structure. The load handling device remains stationary at the charging station while the battery is recharged. The charging period is a significant source of downtime for the load handling device and can be on the order of hours.

To alleviate the problem of charging downtime, the load handling device may be powered by an exchangeable battery. When the battery in the load handling device is depleted, the depleted battery is exchanged for a fully charged battery and therefore the charging downtime is reduced to the time it takes to exchange the battery, rather than being the time to charge the battery.

A load handling device may encounter bumps, vibrations or even crashes when operating on the tracks of the grid storage structure. For a load handling device powered by an exchangeable battery, it is desirable for the battery to be securely held within the load handling device so that the battery does not inadvertently become ejected from the load handling device. There is therefore a need for a battery retention system for securely holding a battery within a battery compartment.

### SUMMARY OF INVENTION

The invention is defined in the accompanying claims.

### Power Source Retention System

The present invention provides a power source retention system comprising: a power source comprising an outer casing and a locking member mounted on top of the outer casing for rotation about a vertical axis relative to the outer casing; a power source compartment configured to removably receive the power source into a power-source-receiving space in a vertical direction, the power source compartment comprising a retention member located adjacent to the power-source-receiving space; wherein when the power source is in the power-source-receiving space, the locking member is rotatable about the vertical axis in a locking direction to a locked position in which the locking member engages the retention member to block the power source from being upwardly removed from the power source compartment, and the locking member is further rotatable in an opposite, unlocking direction about the vertical axis to an unlocked position in which the locking member is unengaged from the retention member to allow the power source to be upwardly removed from the power source compartment.

The locking member may comprise an arm protruding horizontally outwards past the outer casing. The retention member may be configured to engage the arm when the locking member is rotated to the locked position and disengage from the arm when the locking member is rotated to the unlocked position.

The retention member may comprise a retention channel configured to receive the arm when the locking member is rotated to the locked position. The retention channel may be partially defined by a top retention wall configured to substantially block upward movement of the arm to block the power source from being removed from the power source compartment.

The retention channel may be further defined by an end retention wall configured to block further rotation of the arm in the locking direction once the locking member is in the locked position.

The top retention wall may comprise a retention protrusion extending downwardly into the retention channel. The retention protrusion is configured to resist rotation of the locking member in the unlocking direction once the arm is in the locked position. The retention protrusion may be vertically deflectable such that the arm can move past the retaining protrusion once a torque applied to the locking member exceeds a torque threshold.

The arm may comprise a depression configured to receive the retaining protrusion when the locking member is in the locked position.

At least a portion of the top retention wall may be vertically deflectable such that the retention protrusion is vertically deflectable.

The power source retention system may further comprise a stop wall extending over the top retention wall. The stop wall may be vertically spaced from the top retention wall to block vertical deflection of the top retention wall past a threshold deflection. The stop wall may form part of the retention member. The stop wall may be separate to the retention member.

The locking member may be vertically movable relative to the outer casing between a holding position in which a portion of the locking member is engaged with a portion of the outer casing to prevent rotation of the locking member about the vertical axis relative to the outer casing, and a release position in which said portion of the locking member is disengaged from said portion of the outer casing to allow rotation of the locking member about the vertical axis relative to the outer casing.

The locking member may comprise an upper portion and a lower portion. The outer casing may comprise a top wall sandwiched between the upper portion and the lower portion. The upper portion and the lower portion may be rigidly connected together through the top wall. The upper portion may be external to the outer casing. The lower portion may be internal to the outer casing. The vertical distance between the upper portion and the lower portion of the locking member may be configured to allow the locking member to move vertically relative to the top wall of the outer casing. The lower portion may be configured to engage with the top wall when the locking member is in the holding position and disengage from the top wall when the locking member is in the release position. The locking member may be movable upwards towards the holding position and downwards towards the release position. When at rest, the locking member may sit in the release position due to gravity.

A downwards facing surface of the top wall of the outer casing and an opposing, upwards facing surface of the lower portion of the locking member may comprise interlockable features configured to interlock when the locking member is in the holding position to prevent rotation of the locking member about the vertical axis relative to the outer casing and disengage when the locking member is in the release position to allow rotation of the locking member about the vertical axis relative to the outer casing. The interlockable features may be circumferentially arranged about the vertical axis. The interlockable features of may be configured to engage each other in the circumferential direction with respect to the vertical axis when the interlockable features are interlocked to prevent rotation of the locking member relative to the outer casing. The interlockable features may comprise protrusions and corresponding recesses, e.g. protrusions on the downwards facing surface of the top wall of the outer casing and corresponding recesses in the upwards facing surface of the lower portion of the locking member, or vice versa, or a mixture of protrusions and recesses on each of the top wall of the outer casing and the lower portion of the locking member. The interlockable features may comprise castellations, e.g. the downwards facing surface of the top wall of the outer casing may comprise castellations and the upwards facing surface of the lower portion of the locking member may comprise complementary castellations. The outer casing may comprise a mount removably mounted on an external wall (e.g. a top external wall) of the outer casing. The mount may comprise the top wall of the outer casing referred to above.

The outer casing may comprise a top wall. The locking member may comprise an upper portion rigidly connected to a lower portion. The top wall may be sandwiched between the upper portion and the lower portion such that the locking member can rotate relative to the outer casing and the outer casing can be lifted by lifting the locking member.

The vertical distance between the upper portion and the lower portion of the locking member may be configured such that the locking member is vertically moveable relative to the top wall of the outer casing. A downwards facing surface of the top wall of the outer casing and an upwards facing surface of the lower portion of the locking member may comprise interlockable features configured to interlock when the locking member is in an upper position relative to the outer casing to prevent rotation of the locking member relative to the outer casing and disengage when the locking member is a lower position relative to the outer casing to allow rotation of the locking member relative to the outer casing. When at rest, the locking member may sit in the lower position due to gravity. The interlocking features may comprise castellations.

The locking member may comprise a plurality of arms and the power source compartment may comprise a plurality of retention members. Each retention member may be configured to engage a respective arm when the locking member is rotated to the locked position. The plurality of arms may be arranged symmetrically about the vertical axis. The plurality of retention members may be arranged symmetrically about the power-source-receiving space.

The outer casing of the power source may be substantially cuboidal. The power source compartment may be substantially cuboidal. The power-source-receiving space may by substantially cuboidal. The power source compartment and/or the outer casing of the power source may be a shape other than cylindrical (i.e. a shape that is not cylindrical).

The power source may be a battery, e.g. a re-chargeable battery.

The power source may be configured to electrically couple to the power source compartment. The power source may be configured to electrically couple to the power source compartment when the power source is vertically inserted into the power source compartment. The power source may comprise electrical connectors or contacts configured to electrically couple to corresponding electrical connectors or contacts of the power source compartment.

### Load Handling Device

The present invention also provides a load handling device for lifting and moving containers arranged in stacks in a storage structure, the storage structure comprising a track structure, the track structure comprising a first set of tracks and a second set of tracks, the first set of tracks extending in a first direction and the second set of tracks extending in a second direction, the second direction being substantially perpendicular to the first direction, to form a grid pattern defining a plurality of grid cells above the stacks of containers, the load handling device comprising: a driving assembly configured to horizontally move the load handling device on the track structure; a container-holding device configured to releasably hold a container from above; a lifting mechanism configured to raise and lower the container-holding device; and the power source retention system defined above, the power source being configured to electrically couple to the power source compartment to power one or more components of the load handling device.

The driving assembly and/or the container-holding device and/or the lifting mechanism may be powered by the power source.

The power source compartment may be externally accessible from above the load handling device such that the power source can be inserted downwards into the power source compartment from a location above the load handling device. The locking member may be externally exposed when the power source is within the power source compartment.

The load handling device may comprise an external opening in communication with the top of the power source-receiving space to allow a power source to be vertically received into the power source-receiving space via the external opening. Alternatively, the power source compartment may extend through the external opening.

### Power Source Station

The present invention also provides a power source station comprising at least one of the power source retention systems defined above. The or each power source compartment may be arranged such that the or each power source compartment can be accessed from above to vertically insert or remove a power source.

The power source station may comprise a charging system configured to charge a power source when received in any of the power source compartments.

### Power Source Exchange System

The present invention also provides a power source exchange system comprising: the power source retention system defined above and a power source handling device comprising an end effector configured to releasably engage the locking member, and further configured to rotate about the vertical axis to rotate the locking member between the locked position and the unlocked position and move vertically relative to the power source compartment to lower and raise the power source into and out of the power source compartment.

The locking member may comprise a first handling feature and the end effector may comprise a second handling feature. The end effector may be vertically moveable between an engaged position in which the second handling feature engages with the first handling feature when the end effector is rotated in the locking direction and the unlocking direction to allow the end effector to rotate the locking member between the locked position and the unlocked position, and a disengaged position in which the second handling feature is released from the second handling feature such that the end effector is free to rotate relative to the locking member in either the locking or unlocking direction.

The first handling feature may comprise a recess and the second handling feature may comprise a protrusion or vice versa, wherein the recess is configured to receive the protrusion in a circumferential direction to the disengaged position.

The second handling feature may be moveable to an engaged position for engaging the first handling feature in both the locking direction and the unlocking direction to allow the end effector to rotate the locking member in both the locking direction and the unlocking direction. The first and second handling features may be configured such that the second handling feature is moveable to the engaged position by first moving in a circumferential direction towards the first handing feature and subsequently moving upwards to the engaged position.

The locking member may comprise a plurality of first handling features arranged symmetrically about the vertical axis. The end effector may comprise a plurality of second handling features arranged symmetrically about the rotational axis of the end effector. Each of the second handling features may be configured to engage a respective first handling feature when the second handling features are in the engaged position.

The power source handling device may be a robotic arm.

The power source exchange system may further comprise. a load handling device for lifting and moving containers arranged in stacks in a storage structure, the storage structure comprising a track structure, the track structure comprising a first set of tracks and a second set of tracks, the first set of tracks extending in a first direction and the second set of tracks extending in a second direction, the second direction being substantially perpendicular to the first direction, to form a grid pattern defining a plurality of grid cells above the stacks of containers, the load handling device comprising:
a driving assembly configured to horizontally move the load handling device on the track structure;
a container-holding device configured to releasably hold a container from above;
a lifting mechanism configured to raise and lower the container-holding device; and
the power source retention system;
wherein the power source is configured to electrically couple to the power source compartment to power one or more components of the load handling device.

The power source exchange system may further comprise the power source station defined above. The power source handling device may be further configured to move the power source between the power source compartment of the load handling device and any one of the power source compartments of the power source station.

### Storage and Retrieval System

The present invention further provides a storage and retrieval system comprising: a storage structure comprising: a track structure, the track structure comprising a first set of tracks and a second set of tracks, the first set of tracks extending in a first direction and the second set of tracks extending in a second direction, the second direction being substantially perpendicular to the first direction, to form a grid pattern defining a plurality of grid cells; a plurality of upright members supporting the track structure from below to define a storage area below the track structure for storing a plurality of stacks of containers below each grid cell; the storage and retrieval system further comprising the load handling device or the power source exchange system defined above.

The load handling device may be located on the track structure and the power source handling device may be located above or on or adjacent to the track structure to allow the power source handling device to engage a power source of a load handling device on the track structure.

The storage and retrieval system may further comprise the power source station defined above.

The storage and retrieval system may further comprise a plurality of stacks of containers, each stack being arranged below a respective grid cell.

### BRIEF DESCRIPTION OF THE DRAWINGS

The present invention will now be described, by way of example only, with reference to the accompanying drawings, in which:

FIG. 1 is a perspective view of a battery with a locking member rotatable relative to an outer casing.

FIG. 2 is a side cross sectional view of the locking member of the battery of FIG. 1.

FIG. 3 is a top view of the battery of FIG. 1.

FIG. 4 is a perspective view of an arm of the locking member of the battery of FIG. 1.

FIG. 5 is a perspective view of a battery compartment for vertically receiving and retaining

FIG. 6 is a perspective view of the battery of FIG. 1 inside the battery compartment of FIG. 5 with the locking member in an unlocked position.

FIG. 7 is a perspective view of the battery of FIG. 1 inside the battery compartment of FIG. 5 with the locking member in a locked position.

FIG. 8 is a perspective view of a retention member of the battery compartment of FIG. 5.

FIG. 9 is a side cross-sectional view of the retention member of FIG. 8.

FIG. 10 is a bottom perspective view of an end effector for lifting and rotating the locking member of the battery of FIG. 1.

FIG. 11 is a perspective view showing the end effector of FIG. 10 vertically aligned above the battery of FIG. 1.

FIG. 12 is a perspective view of a handling protrusion of the end effector of FIG. 10 being received in a first position in a handling recess of the locking member of the battery of FIG. 1.

FIG. 13 is a perspective view of a handling protrusion of the end effector of FIG. 10 being received in a second position in the handling recess of the locking member of the battery of FIG. 1.

FIGS. 14A-14F are a sequence of drawings showing how the end effector of FIG. 10 can be used to unlock and lift out the battery of FIG. 1 from the battery compartment of FIG. 5.

FIG. 15 is a partial perspective view of an alternative arrangement of the locking member and the outer casing of the battery of FIG. 1.

FIG. 16 is a bottom perspective view of the arrangement of FIG. 15 showing the locking member in a lower, unengaged position relative to the outer casing.

FIG. 17 is a bottom perspective view of the arrangement of FIG. 15 showing the locking member in an upper, engaged position relative to the outer casing which prevents relative rotational movement between the locking member and the outer casing.

FIG. 18 is a perspective view showing an alternative arrangement of the locking member and the outer casing of the battery and a variation of the locking member and the end effector.

FIG. 19 is a schematic cross-sectional view of the arrangement of FIG. 18.

FIG. 20 is a schematic perspective view of a grid storage structure and containers arranged within the grid storage structure.

FIG. 21 is a schematic plan view of a track structure on top of the storage structure of FIG. 20.

FIG. 22 shows load handling devices on top of the track structure of the storage structure of FIG. 20.

FIG. 23 is a schematic perspective view of a load handling device with a container-holding device in a position below the bottom of the load handling device.

FIG. 24 is a schematic perspective view of the load handling device of FIG. 23 with a side panel removed to show a container-receiving space.

FIG. 25 is a schematic perspective view of the load handling device shown in FIG. 24 with a container occupying the container-receiving space.

FIG. 26 is a schematic perspective view of the load handling device shown in FIG. 25 showing an example location for the battery compartment of FIG. 5.

FIG. 27 is a perspective view of a gantry robotic arm arranged above the track structure of the grid storage structure of FIG. 18 and comprising the end effector of FIG. 10 to allow the robotic arm to exchange the battery of the load handling device of FIG. 24 on the track structure.

FIG. 28 is a perspective view of an articulated robotic arm arranged adjacent to the track structure of the grid storage structure of FIG. 20 and comprising the end effector of FIG. 9 to allow the robotic arm to exchange the battery of the load handling device of FIG. 23 on the track structure.

FIG. 29 is a perspective view of a battery station comprising battery station compartments to store the batteries of FIG. 1.

### DETAILED DESCRIPTION

A power source retention system 100 according to the present invention comprises a power source 110 and a power source compartment 150 configured to removably receive the power source 110.

The power source 110 may be a battery, e.g. a rechargeable battery. Throughout the rest of this description, the invention will be described in the context of a battery retention system 100 having a battery 110 and a battery compartment 150. However, the power source 110 is not limited to being a battery and any other suitable form of encased power source for providing electrical power may be used, e.g. a supercapacitor.

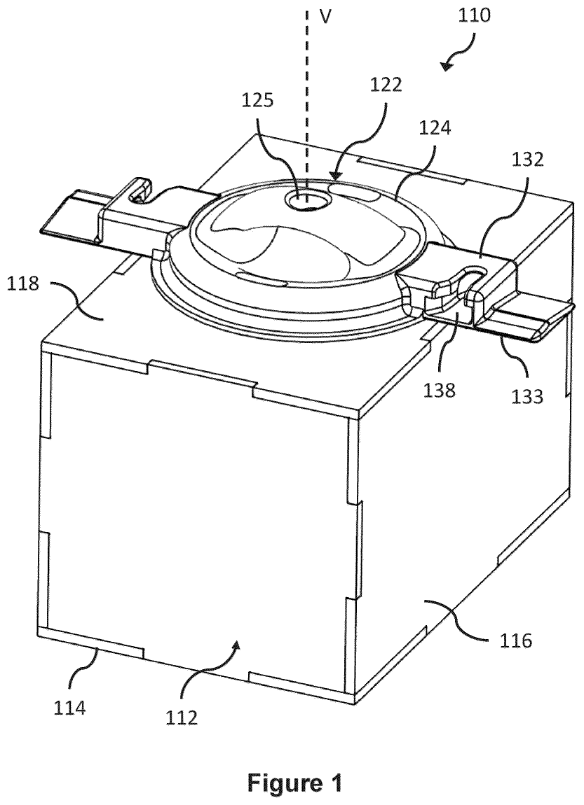

FIG. 1 shows a battery 110 comprises an outer casing 112 which houses battery cells. The outer casing 112 comprises a base 112, sidewalls 116 and a top wall 118 which define an approximate cuboidal shape. The battery 110 further comprises a locking member 122 having a central disc 124 mounted on the top wall 118 for rotation relative to the outer casing 112 about a vertical rotational axis V passing through the centre of the central disc 122.

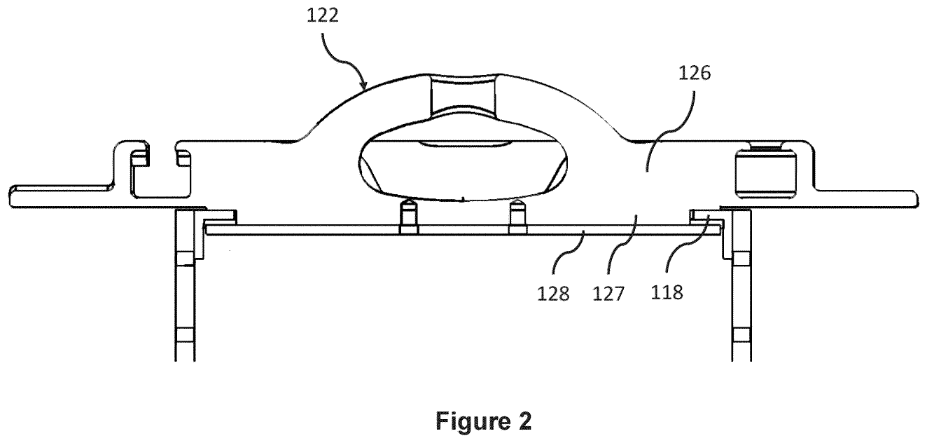

FIG. 2 shows a cross-section of the battery 110 along a vertical plane passing through the centre of the central disc 122. The central disc 122 comprises an upper disc 126 located above the top wall 118 of the outer casing 112 (i.e. external to the outer casing 112) and a lower disc 128 located below the top wall 118 (i.e. inside the outer casing 112). The upper disc 126 is connected to the lower disc 128 via a connecting portion 127 using any suitable connection means (e.g. screws or bolts). The top wall 118 comprises an opening through which the connecting portion 127 extends. The top wall 118 is sandwiched between the upper disc 126 and the lower disc 128 such that the central disc 124 can rotate freely relative to the top wall 118 about the vertical axis and lifting the central disc 124 lifts the outer casing 112 with it.

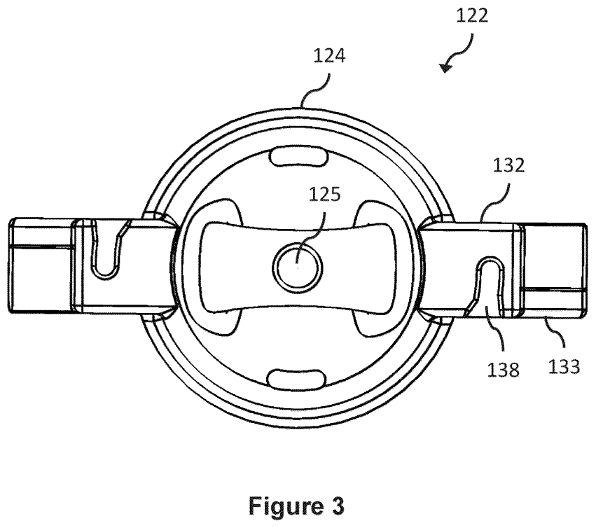

FIG. 3 shows a top view of the locking member 122. The locking member 122 further comprises a pair of arms 132 diametrically opposed about the centre of the central disc 124 and having two-fold rotational symmetry with respect to the vertical axis. The arms 132 are connected to or integrally formed with the upper disc 124 such that the arms 132 rotate with the central disc 124 when the central disc 124 is rotated about the vertical axis. As shown in FIG. 1, when the locking member 122 is mounted on the outer casing 112, the arms are located above the top wall 118 and protrude horizontally outwards past the sidewalls 116 of the outer casing 112.

The locking member 122 further comprises a locating feature 125 in the form of a locating recess 125 located at the centre of the central disc 124 and each arm 132 comprises a handling feature 138 in the form of a handling recess 138. The locating recess 125 and the handling recess 138 are provided to allow an end effector of a robotic arm to interact with the locking member 122 and will be described in more detail later.

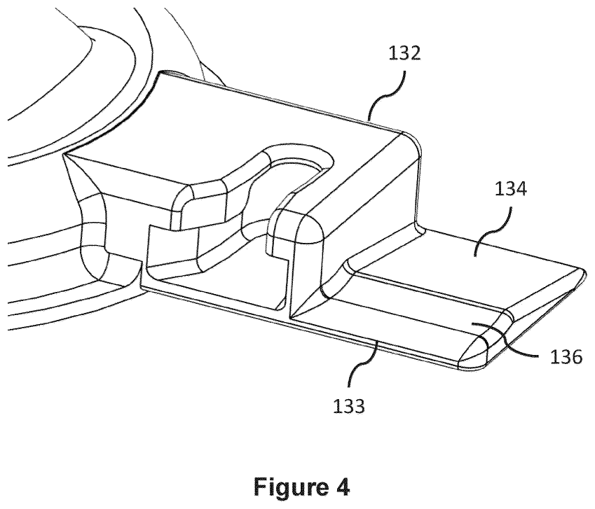

FIG. 4 shows a perspective view of one of the arms 132. Each arm 132 comprises a distal end portion 133 which extends past the sidewalls 116 of the outer casing 112. The distal end portion 133 comprises a downwardly extending depression 136 in a top surface of the distal end portion 133 and a tapered surface 134 which tapers upwards in a tangential direction from a circumferential edge of the distal end portion 133 towards the depression 136. The depression 136 and the tapered surface 134 help the battery 110 to be retained in the power source compartment, as will be described later.

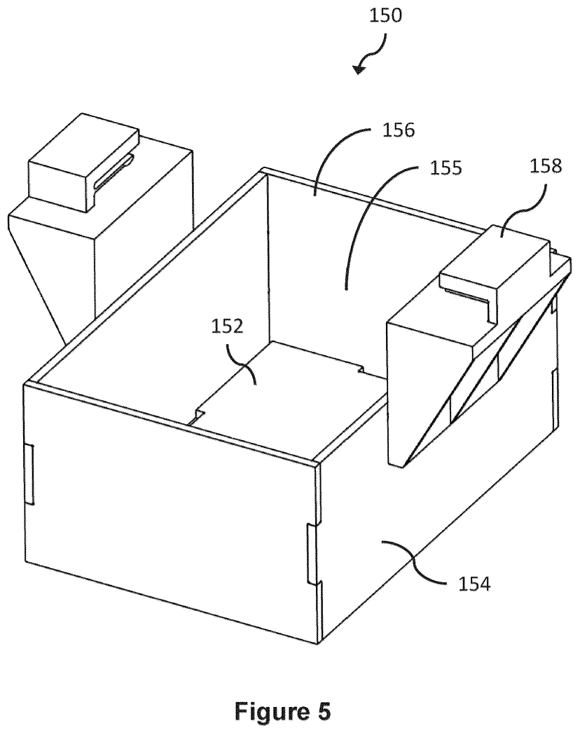

FIG. 5 shows a battery compartment 150 for removably receiving the battery 110 in a downwards direction. The battery compartment 150 comprises a base 152 and sidewalls 154 extending upwards from the base 152 to at least partially define an approximately cuboidal battery-receiving space 155 with a top opening 156 through which the battery 110 is received into and removed from the battery compartment 150 in a vertical direction. The battery compartment 150 may comprise one or more contacts or connectors (not shown) configured to connect to corresponding contacts or connectors on the battery 110 (not shown) when the battery 110 is inserted into the battery compartment 150 to transfer power from the battery 110 to the battery compartment 150 and any electrical or electronic components coupled to the battery compartment. For example, the battery compartment 150 may comprise upward-facing contacts configured to couple to downward-facing contacts on the battery 110 when the battery 110 is vertically received into the power source compartment 150.

The battery compartment 150 further comprises a pair of retention members 158 mounted to a pair of opposing sidewalls 154 of the battery compartment 150 such that the retention members 158 are located on opposing lateral sides of the battery-receiving space 155, near or at the top of the battery-receiving space 155.

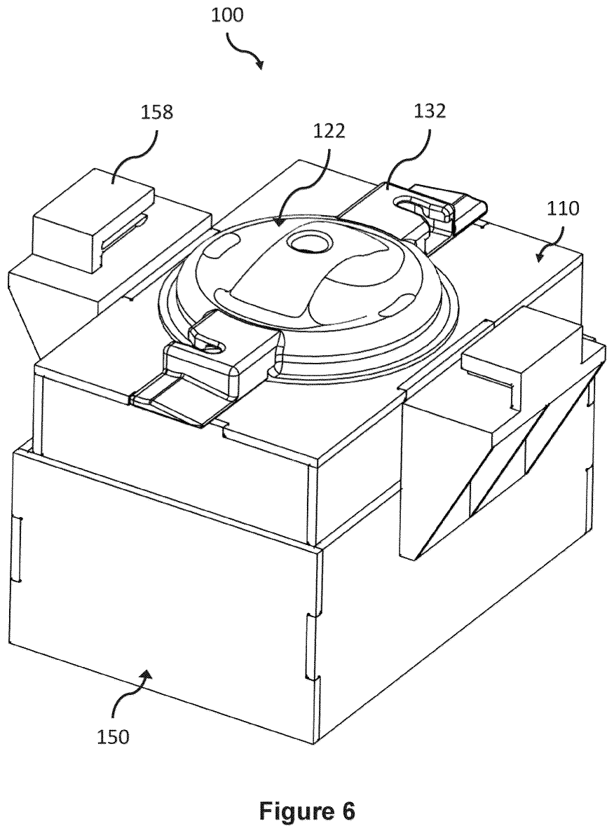

FIG. 6 shows a battery 110 received in the battery-receiving space 155 of the battery compartment 150. In FIG. 6, the arms 132 of the locking member 122 are in an unlocked position such that the battery 110 can be freely inserted into and removed from the battery compartment 150 in a vertical direction.

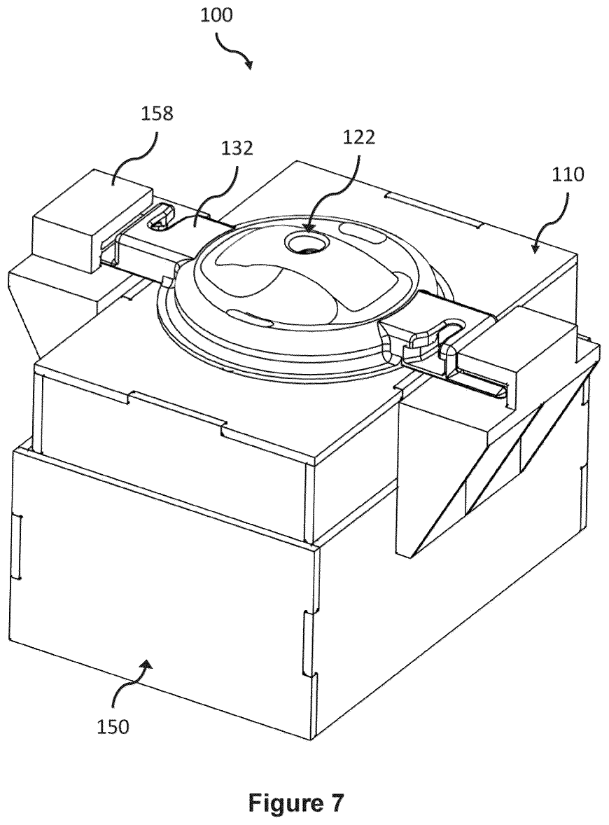

FIG. 7 shows the arms 132 in a locked position in which the distal end portions 133 of the arms 132 have been received by the retention members 158. The retention members 158 are configured to block the arms 132 moving in an upwards direction, which blocks the whole battery 110 from being lifted out of the battery compartment 150.

In use, the arms 132 are moved from the unlocked position to the locked position by rotating the locking member 122 in a locking direction about its rotational axis and are moved from the locked position to the unlocked position by rotating the locking member 122 in an opposite, unlocking direction about its rotational axis. In this illustrated example, the locking direction is anti-clockwise and the unlocking direction is clockwise.

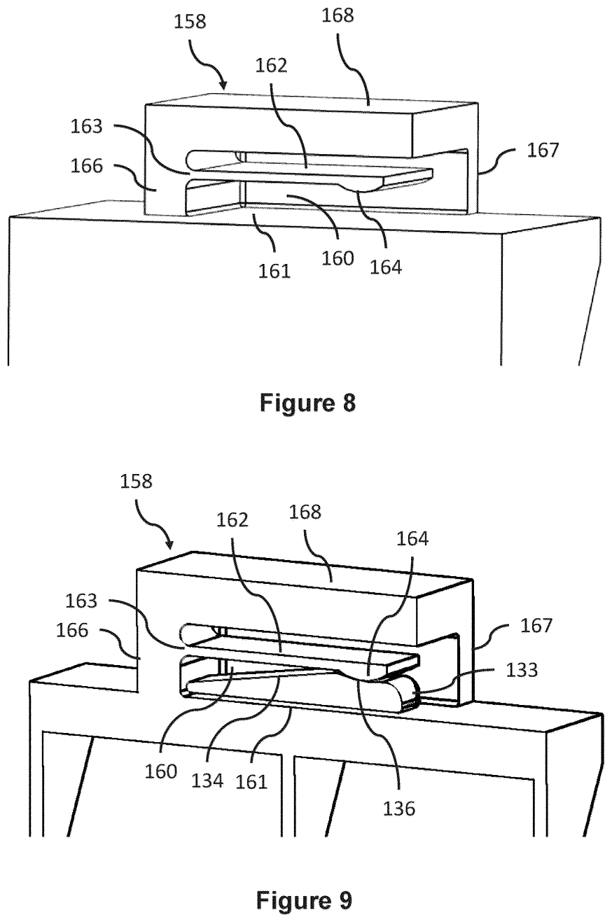

FIG. 8 shows a perspective view of a retention member 158. The retention member 158 comprises a horizontally extending retention channel 160 defined between a top retention wall 162 and a bottom retention wall 161. The retention channel 160 is open at one lateral end to receive the distal end portion 133 of one of the arms 132 when the arm 132 is rotated in the locking direction. The retention channel 160 is bound at the other end by an end retention wall 166. The retention member 158 is configured such that the end retention wall 166 extends upwardly from the bottom retention wall 161 and the top retention wall 162 extends horizontally from the end retention wall 166. The top retention wall 162 comprises a retention protrusion 164 protruding downwardly into the retention channel 160. The retention protrusion 164 is positioned within the retention channel 160 such that the distal end portion 133 of the arm 132 is required to push past the retention protrusion 164 when moving between the locked position and the unlocked position.

FIG. 9 shows a side cross-sectional view of the retention member 158 with the arm 132 in the locked position (i.e. fully received in the retention channel 160). It can be seen that in the locked position, the distal end portion 133 of the arm 132 is blocked from moving upwards by the top retention wall 162, is blocked from moving further in the locking direction by the end retention wall 166, and is blocked from moving in the downwards direction by the bottom retention wall 161. It can also been seen that in the locked position, the retention protrusion 164 of the top retention wall 162 sits in the depression 136 of the distal end portion 133 of the arm 132 such that rotation of the arm 132 in the unlocking direction is resisted.

To allow the distal end portion 133 of the arm 132 to move past the retention protrusion 164 when moving between the locked position and the unlocked position, a connecting portion 163 between the top retention wall 162 and the end retention wall 166 has some resiliency such that the top retention wall 162 and the retention protrusion 164 can be vertically deflected about the connecting portion 163. Alternatively, another portion of the top retention wall 162 and/or the retention protrusion 164 may have some resiliency such that the top retention wall 162 and/or the retention protrusion 164 can be elastically deflected away from the bottom retention wall 161. Thus, when the arm 132 is in the locked position and a torque greater than a torque threshold is applied to the locking member, the arm 132 can deflect the retention protrusion 164 upwards out of the depression 136 to allow the arm 132 to leave the retention channel 160 in the unlocking direction, but if the torque applied to the locking member 122 is less than the torque threshold, the retention protrusion 164 will remain in the depression 136 and stop the arm 132 leaving the retention channel 160 in the unlocking direction. In this way, the battery 110 is likely to remain locked within the battery compartment 150 during minor bumps and shocks to the battery retention system 100 but can be unlocked by a deliberate rotation of the locking member 122 in the unlocking direction.

Similarly, this resiliency allows the arm 132 to push past the retention protrusion 164 to enter the retention channel 160 when the locking member 122 is rotated from the unlocked position to the locked position. The tapered portion 134 of the distal end portion 133 of the arm 132, which tapers upwards to the depression 136, also helps to allow the distal end portion 133 to slide past the retention protrusion 164 and push it upwards before the retention protrusion 164 enters the depression 136. Alternatively or in addition, the retention protrusion 164 may comprise a tapered or rounded surface.

To further help prevent the arm 132 from accidently moving out of the locked position from the retention channel 160, the retention member 158 further comprises a top stop wall 168 that extends over the top retention wall 162. The retention member 158 is configured such that the stop wall 168 extends horizontally from the end retention wall 166. The retention member 158 further comprises a back retention wall 167 located on an outer side of the retention member 158 (with respect to the centre of the battery compartment 150) that extends between the stop wall 168, the bottom retention wall 161 and the end retention wall 166. The end retention wall 166, the back retention wall 167, and the stop wall 168 form a rigid structure extending over the top of the top retention wall 162. The stop wall 168 is vertically spaced from the top retention wall 162 such that the stop wall 168 blocks the top retention wall 162 from deflecting upwards past a particular vertical distance (i.e. the stop wall 168 provides a hard stop for the upwards deflection of the top retention wall 162). In this way, the risk of the top retention wall 162 snapping (e.g. at the connection portion 163) or deflecting too far away from the bottom retention wall 161 such that the arm 132 “jumps” out of the retention channel 160 is decreased during a more violent bump or shock of the battery retention system 100.

Instead of the stop wall 168 being part of the retention member 158, the stop wall 168 may instead be a separate component (i.e. not integrally formed with the other walls of the retention member, or not connected to any of the walls of the retention member 158) that extends over the top retention wall 162 to perform the same function of providing a hard stop for the upward deflection of the top retention wall 162. In this case, the stop wall 168 may be mounted separately to the retention member 158 on a sidewall 154 of the battery compartment 150, or on another structure that is not part of the battery compartment 150.

Referring back to FIG. 6 and FIG. 7 it can be seen that the retention members 158 are orientated such that the arrangement of the retention members 158 with respect to the centre of the battery compartment 150 (or the centre of the battery-receiving space 155) has two-fold symmetry. Thus, when the locking member 122 is rotated in the locking direction, each arm 132 is substantially simultaneously received in a corresponding retention member 158.

The battery retention system 100 may form part of an automated battery exchange system in which a battery 110 can be inserted into or removed from the battery compartment 150 using a robotic arm or other automated handling device. The robotic arm may, for example, be a gantry robot, or Cartesian robot in which an end effector is movable along three orthogonal directions, or the robotic arm may be an articulated robot comprising rotary joints which provide greater axes and degrees of freedom.

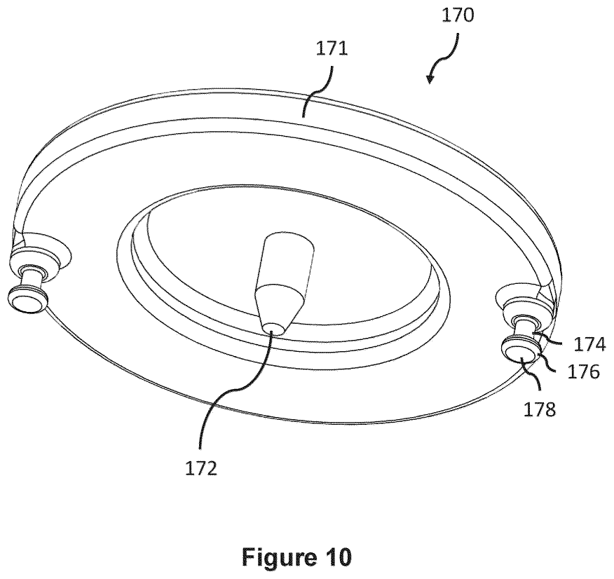

FIG. 10 shows a bottom perspective view of an end effector 170 that may be used with a robotic arm to engage the locking member 122 from above to pick up and rotate the battery 110. The end effector 170 comprises a disc-shaped head 171 which is mounted at the end of a robotic arm for rotational movement about a rotational axis extending through the centre of the head 171. The bottom of the head 171 comprises a downwardly extending central locating protrusion 172 and a pair of downwardly extending, diametrically opposed handling protrusions 178 arranged equidistant from the centre of the head 171. Each handling protrusion 178 comprises a stem portion 176 leading to a distal bulb portion 178 having a greater width (diameter) than the stem portion 176.

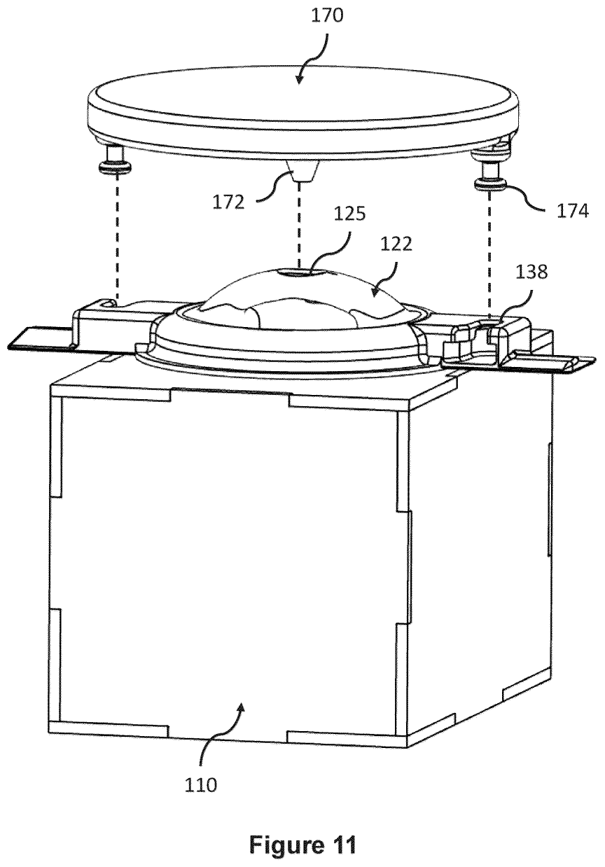

FIG. 11 shows the end effector 170 positioned above the locking member 122 of the battery 110, with the rotational axis of the end effector 170 aligned with the rotational axis of the locking member 122. As indicated by the dashed lines in the figure, the locating protrusion 172 and the handling protrusions 174 are arranged on the head 171 such that when the locating protrusion 172 of the end effector 170 is vertically aligned with the locating recess 125, the handling protrusions 174 can be vertically aligned with the handling recesses 138, i.e. the handling protrusions 174 are the same radial distance away from the centre of the head 171 as the handling recesses 138 are from the centre of the locking member 122. The locating protrusion 172 and/or the locating recess 125 may be tapered (e.g. have a conical or frustoconical shape) such that the locating protrusion can self-align with the locating recess 125 via sliding contact when the end effector 170 is being lowered towards the locking member 122.

The locating recess 125 of the locking member 122 is configured to receive the locating protrusion 172 of the end effector 170 in a downwards direction and the handling recesses 138 are configured to receive the handling protrusions 174 in a circumferential direction (the locking direction in this example).

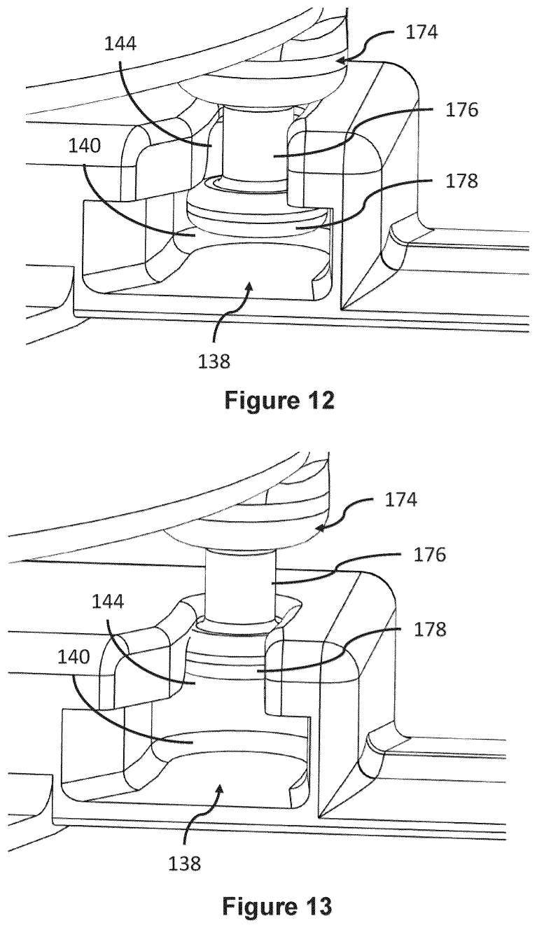

FIG. 12 and FIG. 13 show a close-up perspective view of one of the handling recesses 138. Each handling recess 138 comprises a lower handling recess 140 in communication with an upper handling recess 144. The lower handling recess 140 is sized and configured such that it can receive the bulb portion 178 of the handling protrusion 174 in a first circumferential direction. In particular, the width of the entrance to the lower handling recess 140 in the first circumferential direction is larger than the width (diameter) of the bulb portion 178. The upper handling recess 144 is sized and configured such that it can receive the stem portion 176 of the handling protrusion 174 in the first circumferential direction but not the bulb portion 178. In particular, the width of the entrance to the upper handling recess 144 in the first circumferential direction is larger than the width (diameter) of the stem portion 176 but is smaller than the width (diameter) of the bulb portion 178. The upper handling recess 144 and the lower handling recess 140 are in communication such that the bulb portion 178 can move upwards into the upper handling recess 144 from the lower handling recess 140. In particular, the end effector 170 is vertically moveably between a lower, disengaged position in which the bulb portion 178 is in the lower handling recess 140 and an upper, engaged position in which the bulb portion 178 is in the upper handling recess 144. The upper handling recess 144 is further sized and configured such that once the bulb portion 178 has been received into the upper handling recess 144, the walls defining the upper handling recess 144 substantially block further movement of the bulb portion 178 in the upwards direction, which allows the end effector 170 to pick the locking member 122 up, and hence pick the battery 110 up. Furthermore, the walls defining the upper handling recess 144 substantially block movement of the bulb portion 178 in both the first and second circumferential directions, therefore allowing the end effector 170 to rotate the locking member 122 is either circumferential direction.

An advantage of this arrangement is that the end effector 170 can engage and disengage from the locking member 122 to lock, unlock, raise and lower the battery using a mechanically simple end effector that carries out a series of simple rotational and vertical movements, rather using than a more complex end effector such as a gripping end effector.

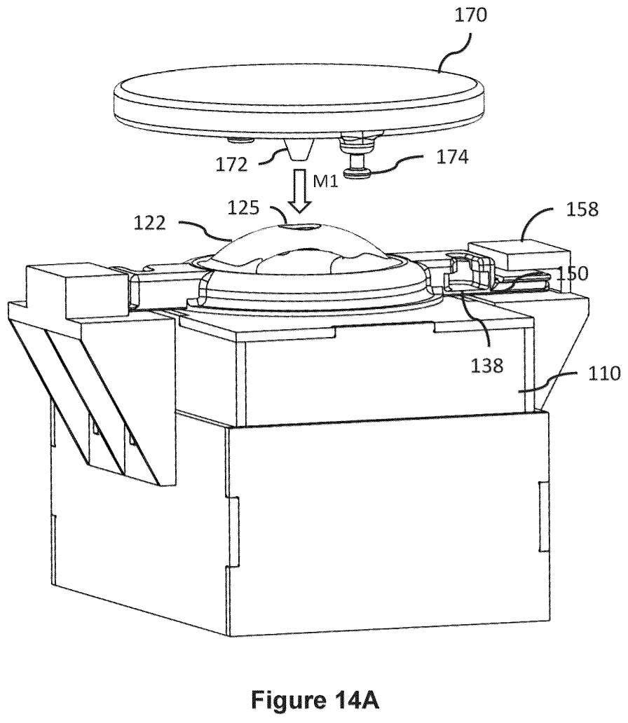

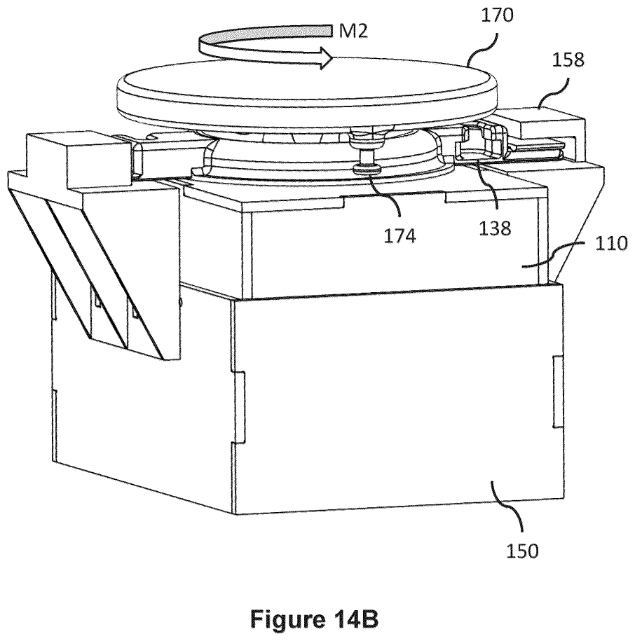

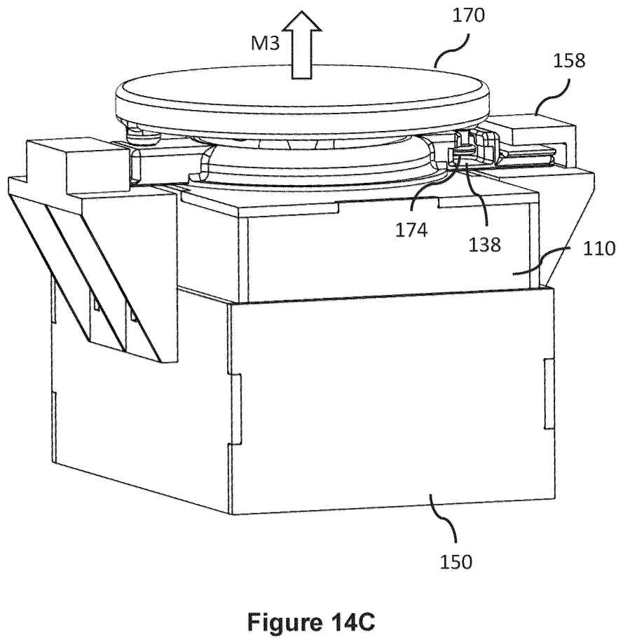

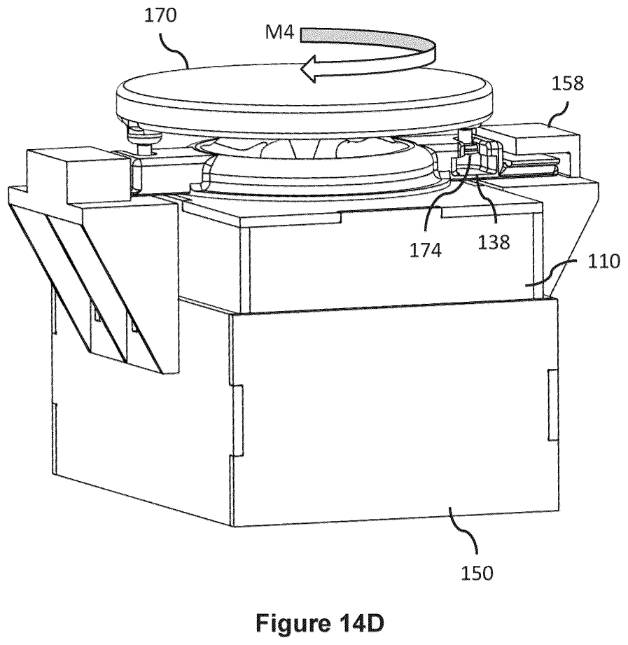

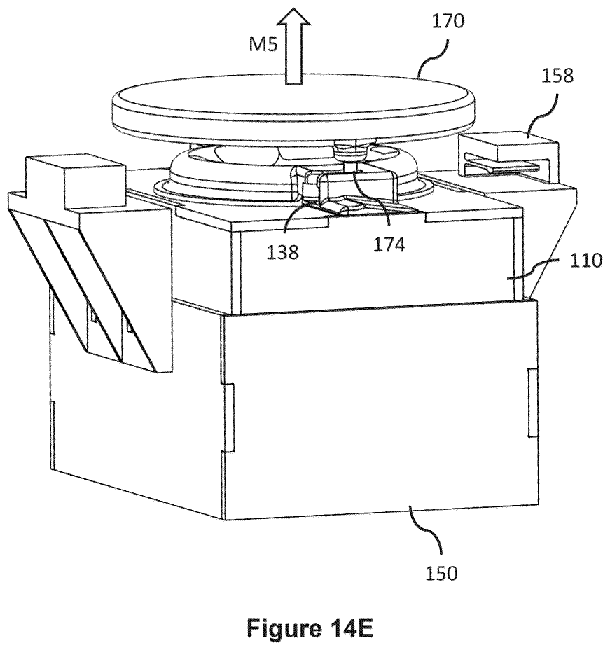

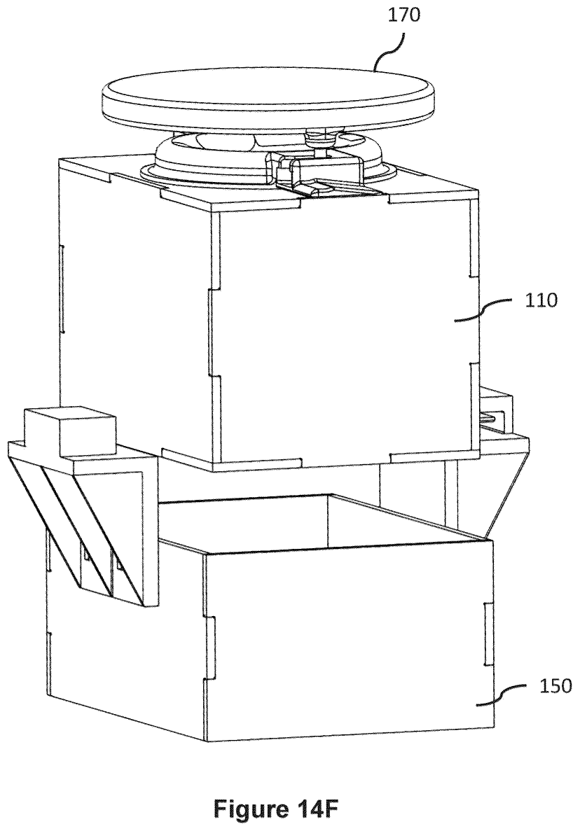

FIGS. 14A-14F are a sequence of drawings showing how the end effector 170 can unlock and remove a battery from the battery compartment. In FIG. 14A, the battery is in the battery compartment and the locking member is in the locked position. The end effector 170 is positioned above the locking member 122 with the locating protrusion 172 approximately above the locating recess 125 and the handling protrusions 174 at circumferential positions that are not above the handling recesses 138 (i.e. the handling protrusions 174 are located at angular positions between the handling recesses 138 in the circumferential direction with respect to the rotational axis). The end effector 170 is then lowered in the direction of arrow M1 to the state show in FIG. 14B. In FIG. 14B, the end effector 170 has been lowered until the locating protrusion 172 is engaged with the locating recess 125 and the bulb portions 178 of the handling protrusions are lying in the same horizontal plane as the lower handling recesses 140 (i.e. the bulb portions 178 are substantially horizontally level with the lower handling recesses 138). The end effector 170 is then rotated in the locking direction indicated by arrow M2 to the state shown in FIG. 14C. In FIG. 14C, the end effector 170 has been rotated in the locking direction to the disengaged position, i.e. the stem portions 176 and the bulb portions 178 have been received in the upper handling recesses 144 and the lower handling recesses 140 respectively. The end effector 170 is then raised in the direction of arrow M3 to the state shown in FIG. 14D. In FIG. 14D, the end effector 170 has been raised to the engaged position such that the bulb portion 178 is now in the upper handling recess 144. The end effector 170 is then rotated in the unlocking direction indicated by arrow M4 to the state shown in FIG. 14E. In FIG. 14E, rotation of the end effector 170 in the unlocking direction while in the upper position has caused the locking member 122 to rotate in the unlocking direction until the arms 132 are clear of the retention members 158, i.e. they have exited the retention channel 160 and are no longer blocked from moving in the upwards direction. The end effector 170 is then raised in the direction of arrow M5 to the state shown in FIG. 14F. In FIG. 14F, the end effector 170 has been raised such that the battery 110 has been lifted out of the battery compartment 150.

To insert and lock a battery 110 into the battery compartment 150, the above steps can be carried out in reverse. The above method can be used to exchange a battery 110 in the battery compartment 150 by carrying out the above method to release and remove a battery 110 from the battery compartment 150 and then carrying out the above method in reverse to insert and lock another battery 110 into the battery compartment 150. This may be used, for example, to replace a depleted battery 110 with a charged battery 110.

The battery 110 and battery compartment 150 may be positioned in a predictable and repeatable position relative to the robotic arm such that the robotic arm can be programmed to perform predetermined movements to move and orientate the end effector with respect to the locking member 122 to move the battery 110 into or out of the battery compartment 150. Alternatively, or in addition, the robotic arm may comprise sensors or a machine vision system to allow the robotic arm to determine the location and orientation of the locking member 122 using methods known in the art.

Although the battery compartment 150 has been described above as being defined by a base 152 and sidewalls 154, with the retention members 122 being mounted to the sidewalls, the battery compartment 150 is not limited to this configuration. Instead, the battery compartment 150 may simply be a region of space into which the battery 110 is received, with electrical connectors or contacts appropriately positioned to connect to corresponding connectors or contacts on the battery 110. In this case, the retention members 122 may be mounted on another structure adjacent to the top of the battery-receiving space 155.

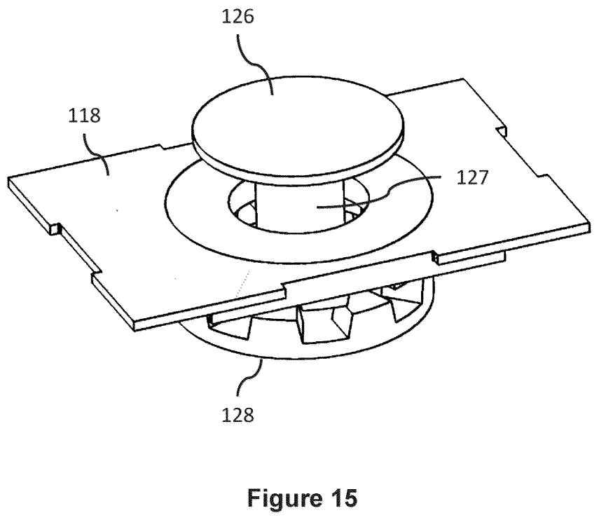

In the above-described example battery retention system 100, the locking member 122 may undesirably rotate relative to the outer casing 112 of the battery 110 while the battery 110 is being held up via the locking member 122. FIGS. 15-17 show an arrangement of the locking member 122 and the outer casing 112 that helps to prevent relative rotation between the locking member 122 and the outer casing 112 while the battery 110 is being held up via the locking member 122. This may be useful to ensure that the outer casing 112 remains in the same orientation while the battery 110 is being transported between two different locations (e.g. between two battery compartments) so that placement of the battery 110 by the robotic arm is more likely to be accurate and reliable.

FIG. 15 shows the top wall 118 of the outer casing 112, and the upper disc 126 and lower disc 128 of the locking member 122. Other features of the battery retention system 100 have been omitted for clarity. In this example, the connecting portion 127 between the upper disc 126 and the lower disc 128 is configured such that the locking member 122 can move vertically (i.e. in an axial direction parallel to the rotational axis of the locking member) relative to the top wall 118. In particular, the length of the connecting portion 127 is greater than the thickness of the top wall 118.

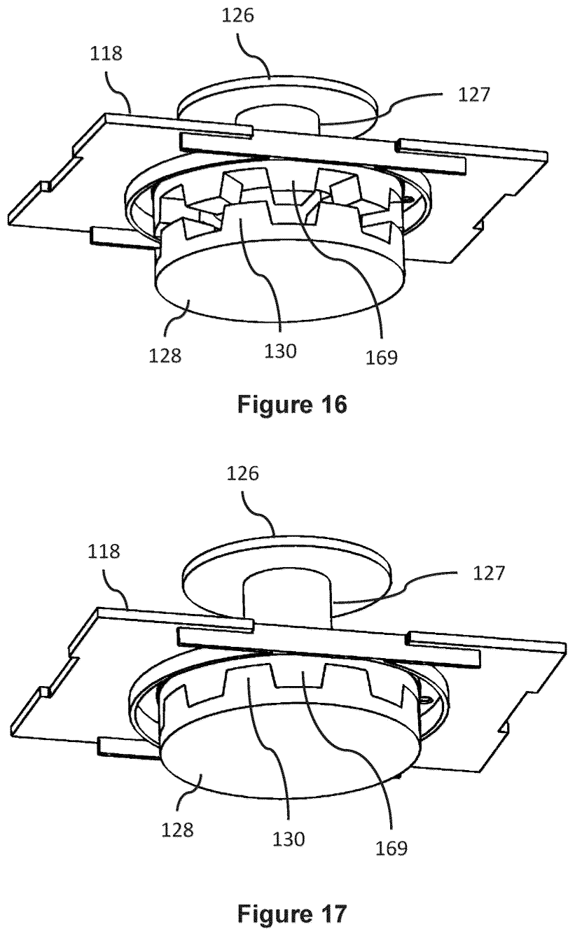

FIG. 16 and FIG. 17 show the arrangement of FIG. 15 viewed from below the top wall 118. The top surface of the lower disc 128 comprises castellations 130 (i.e. a series of alternating protrusions and recesses) extending around the circumference of the lower disc 128. In other words, the castellations are circumferentially arranged about the rotational axis of the locking member 122. Similarly, the opposing bottom surface of the top wall 118 comprises complementary castellations 120 circumferentially arranged about the rotational axis of the locking member 122. FIG. 16 shows the locking member in a release position when the locking member 122 is at rest under gravity. The length of the connecting portion 127 is configured such that when the locking member 122 is in the release position, the castellations 130 of the lower disc 128 and the castellations 120 of the top wall 118 are vertically spaced apart such that they are not engaged (i.e. they do not interlock). FIG. 17 shows the locking member in a holding position when an end effector 170 has picked up the battery 110 via the locking member 122 such that the locking member 122 has moved upwards towards the top wall 118. In the holding position, the castellations 130, 120 are interlocked with each other such that the castellations 130, 120 can engage each other in the circumferential direction to prevent relative rotational movement between the locking member 122 and outer casing 112 about the vertical rotational axis of the locking member 112.

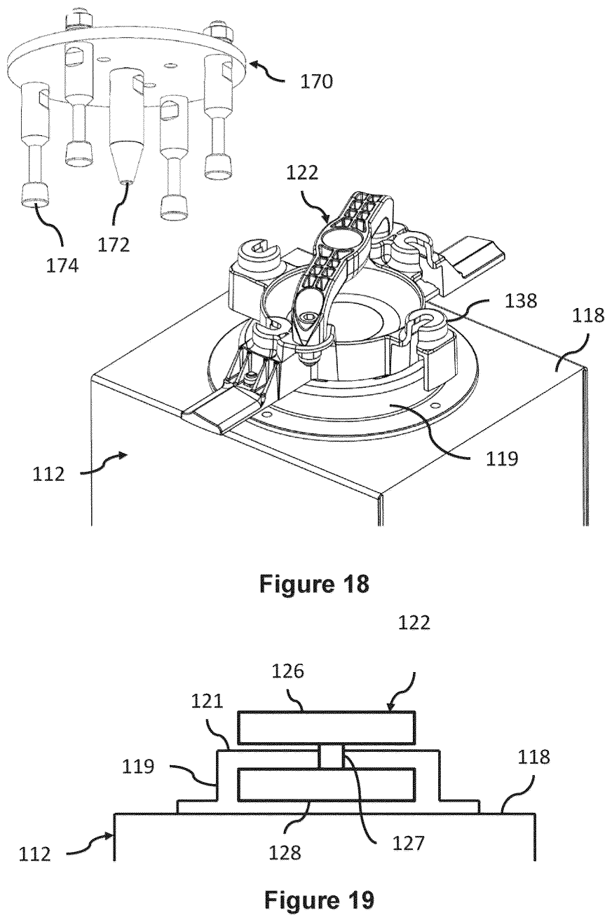

FIG. 18 shows a variation of the battery retention system 100 in which the outer casing 112 further comprises a mount 119 mounted on the previously described top wall 118 of the outer casing 112. In this variation, a top wall 121 of the mount 119 is configured and interacts with the locking member 122 in the same way as the top wall 118 of the previous variation. FIG. 19 shows a schematic vertical cross section through the assembly shown in FIG. 18. The top wall 121 of the mount 119 is sandwiched between the upper disc 126 and the lower disc 128 of the locking member 122. The upper disc 126 is rigidly connected to the lower disc 128 by a connecting portion 127 extending through an opening in the top wall 121 of the mount 119 such that the locking member 122 is vertically moveable relative to the top wall 121 of the mount 119 between a handling position and a release position. A top surface of the lower disc 128 and a bottom surface of the top wall 121 of the mount 119 comprise complementary castellations (not shown) which are configured to interlock in the handling position and disengage in the release position to prevent and allow relative rotation of the locking member and the outer casing 112 respectively, as already described above.

The locking member 122 and mount 119 can be conveniently retrofitted to existing battery casings by assembling the locking member 122 with the mount 119 and then mounting the assembled locking member 122 and mount 119 to the top wall of the outer casing of an existing battery.

FIG. 18 also shows a variation of the locking member 122 and the end effector 170 in which the locking member 122 comprises four handling recesses 138 arranged symmetrically about the rotational axis of the locking member 122 and the end effector 170 comprises four handling protrusions 174 arranged symmetrically about the rotational axis of the end effector 170. The handling recesses 138 and the handling protrusions 174 of this variation have a similar shape as the handling recesses 138 and handling protrusions 174 in the previously described example and are configured to function and interact in the same way to allow the end effector 170 to pick up and release the battery 110 and rotate the locking member 122.

The battery retention system 100 may be used in one or more battery-powered robotic load handling devices which operate in a storage and retrieval system.

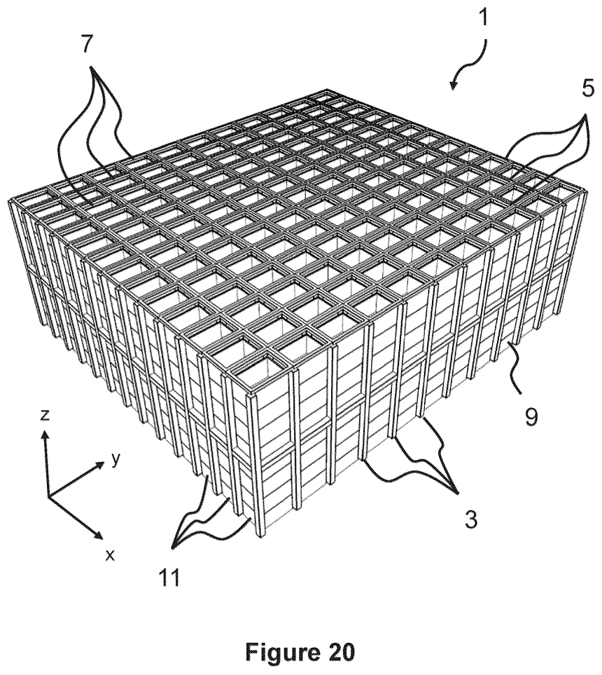

FIG. 20 shows an example storage structure 1 that may be used in a storage and retrieval system to store storage containers 9. The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14. In the illustrated example, storage containers 9 are arranged in stacks 11 beneath the grid cells 14 defined by the grid pattern, one stack 11 of storage containers 9 per grid cell 14.

As an alternative to the upright members 3 supporting the horizontal members 5,7 as described with reference to FIG. 20, in other examples the horizontal members can be supported by support framework structure comprising a plurality of prefabricated modular panels arranged in a grid pattern, the detail of which is described in the PCT application WO2022034195A1. The storage structure described in WO2022034195A1 addresses the problem of time and cost to assemble by providing a supporting framework structure comprising a plurality of prefabricated modular panels arranged in a three dimensional grid pattern to define a plurality of grid cells. Each of the grid cells of the supporting framework structure is sized to support two or more grid cells of the track structure. The storage structure is formed from fewer structural components yet still maintains the same structural integrity as the typical “stick-built” storage structure 1 described above, and is much faster and cheaper to build. Any appropriate supporting framework structure can be used in the current invention.

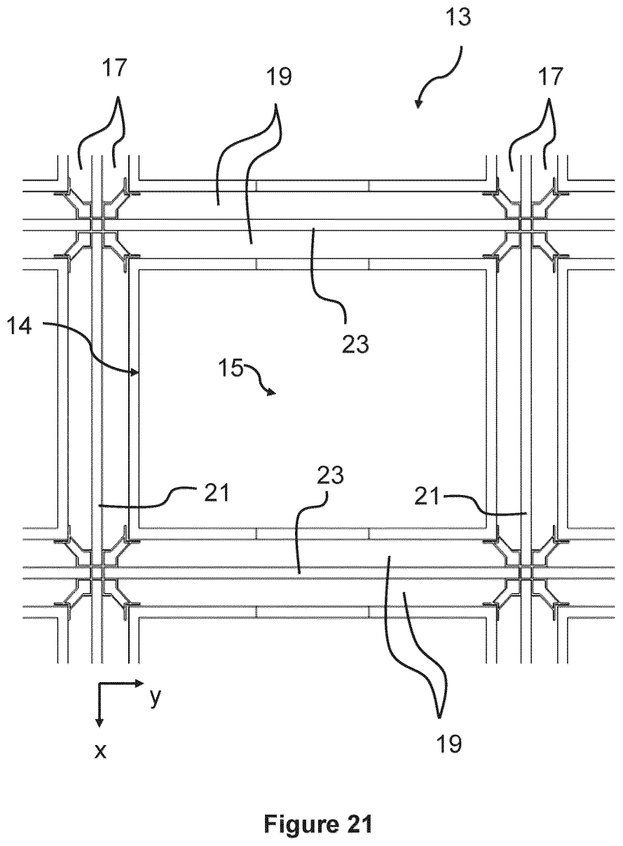

FIG. 21 shows a large-scale plan view of a section of track structure 13 forming part of the storage structure 1 illustrated in FIG. 20 and located on top of the horizontal members 5, 7 of the storage structure 1 illustrated in FIG. 20. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells 14. The apertures 15 are sized to allow storage containers 9 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible.

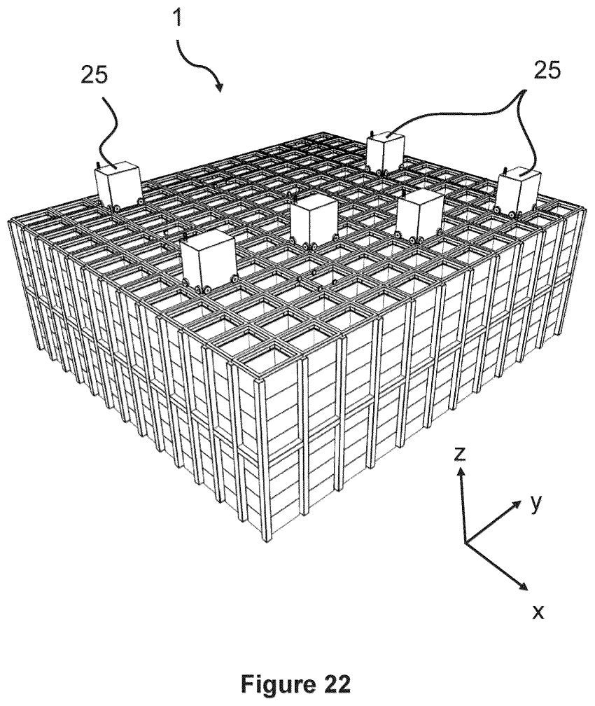

FIG. 22 shows a plurality of load handling devices 25 moving on top of the storage structure 1 illustrated in FIG. 20. The load handling devices 25, hereinafter referred to as “bots”, are provided with sets of wheels to engage with corresponding x-or y-direction tracks 17, 19 to enable the bots 25 to travel across the track structure 13 and reach specific grid cells 14. The illustrated pairs of tracks 17, 19 separated by channels 21, 23 allow bots 25 to occupy (or pass one another on) neighbouring grid cells 14 without colliding with one another.

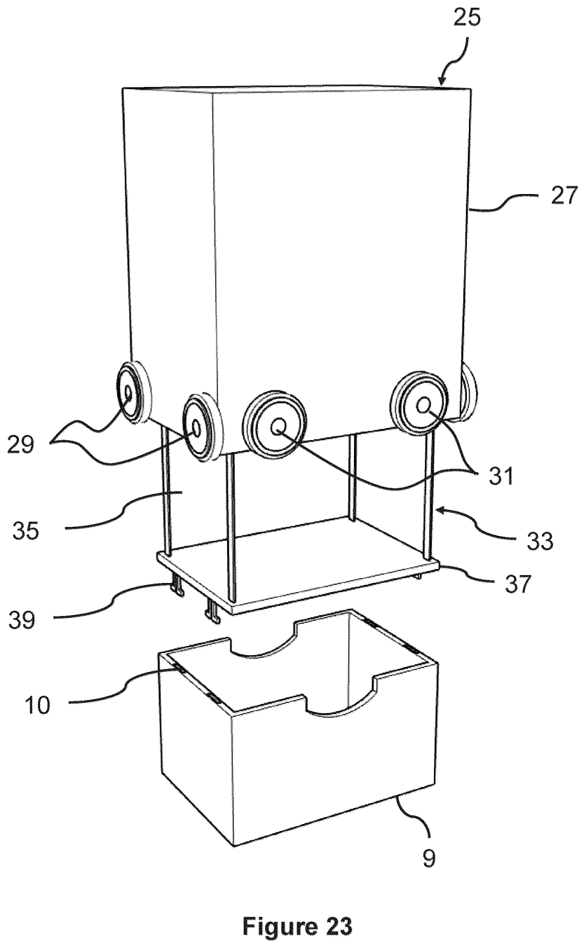

As illustrated in FIG. 23, a bot 25 comprises a body 27 in or on which are mounted one or more components which enable the bot 25 to perform its intended functions. These functions may include moving across the storage structure 1 on the track structure 13 and raising or lowering storage containers 9 (e.g. from or to stacks 11) so that the bot 25 can retrieve or deposit storage containers 9 in specific locations defined by the grid pattern.

The illustrated bot 25 comprises a driving assembly comprising first and second sets of wheels 29, 31 which are mounted on the body 27 of the bot 25 and enable the bot 25 to move in the x-and y-directions along the tracks 17 and 19, respectively. In particular, two wheels 29 are provided on the shorter side of the bot 25 visible in FIG. 23, and a further two wheels 29 are provided on the opposite shorter side of the bot 25. The wheels 29 engage with tracks 17 and are rotatably mounted on the body 27 of the bot 25 to allow the bot 25 to move along the tracks 17. Analogously, two wheels 31 are provided on the longer side of the bot 25 visible in FIG. 23, and a further two wheels 31 are provided on the opposite longer side of the bot 25. The wheels 31 engage with tracks 19 and are rotatably mounted on the body 27 of the bot 25 to allow the bot 25 to move along the tracks 19.

To enable the bot 25 to move on the different wheels 29, 31 in the first and second directions, the driving assembly further comprises a wheel-positioning mechanism (not shown) for selectively engaging either the first set of wheels 29 with the first set of tracks 17 or the second set of wheels 31 with the second set of tracks 19. The wheel-positioning mechanism is configured to raise and lower the first set of wheels 29 and/or the second set of wheels 31 relative to the body 27, thereby enabling the load handling device 25 to selectively move in either the first direction or the second direction across the tracks 17, 19 of the storage structure 1.

The wheel-positioning mechanism may include one or more linear actuators, rotary components or other means for raising and lowering at least one set of wheels 29, 31 relative to the body 27 of the bot 25 to bring the at least one set of wheels 29, 31 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 27 of the bot 25 stays substantially at the same height and therefore the weight of the body 27 and the components mounted thereon does not need to be lifted and lowered by the wheel-positioning mechanism.

The bot 25 also comprises a lifting mechanism 33 and a container-holding device 37 configured to raise and lower storage containers 9. The illustrated lifting mechanism 33 comprises four tethers 35 which are connected at their lower ends to the container-holding device 37. The tethers 35 may be in the form of cables, ropes, tapes, or any other form of tether with the necessary physical properties to lift the storage containers 9. The container-holding device 37 comprises a gripping mechanism 39 configured to engage with features of the storage containers 9 to releasably hold the containers 9 from above. In the illustrated example, the gripping mechanism 39 comprises legs that can be received in corresponding apertures 10 in the rim of the storage container 9 and then moved outwards to engage with the underside of the rim of the storage container 9. The tethers 35 can be wound up or down to raise or lower the container-holding device 37 as required. One or more motors and winches or other means may be provided to effect or control the winding up or down of the tethers 35.

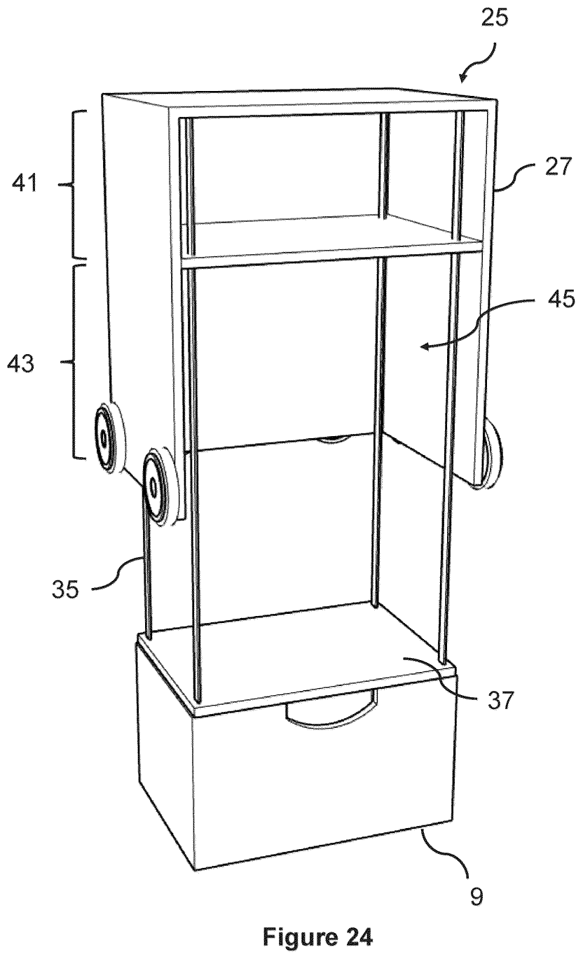

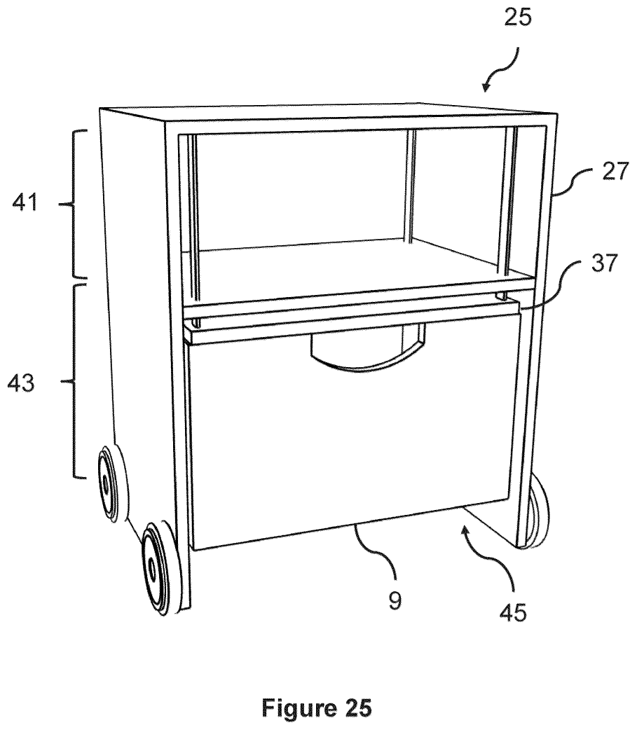

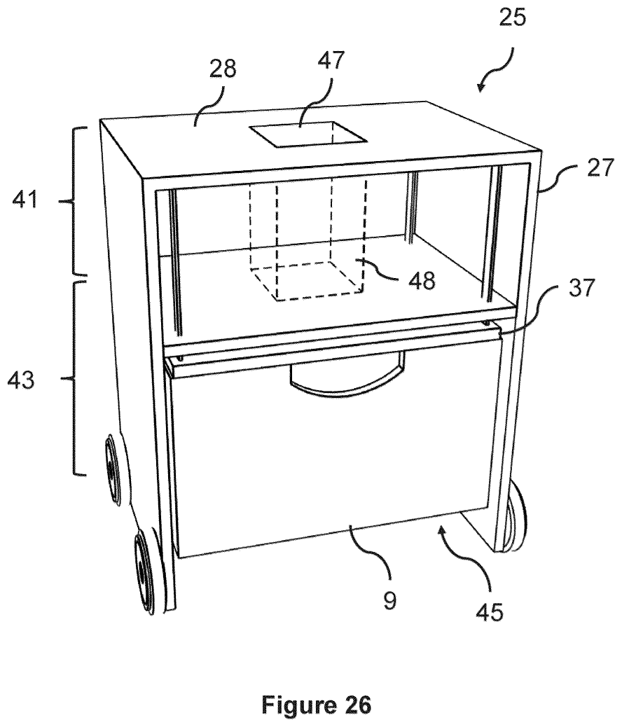

In FIG. 24, a side panel of the bot 25 has been omitted from view to allow the interior of the bot 25 to be seen. The body 27 of the illustrated bot 25 has an upper portion 41 and a lower portion 43. The upper portion 41 is configured to house or support one or more operation components (not shown), such as components of the lifting mechanism 33 (e.g. motors), wireless communication components, one or more processors for controlling operation of the bot 25, etc. The lower portion 43 is arranged beneath the upper portion 41. The lower portion 43 is externally open at the bottom and defines a container-receiving space 45 for accommodating at least part of a storage container 9 that has been raised into the container-receiving space 45 by the lifting mechanism 33. FIG. 24 shows the container-receiving space 45 before it is occupied by a storage container 9 and FIG. 25 shows the container-receiving space 45 after it has been occupied by a storage container 9. The container-receiving space 45 is sized such that enough of a storage container 9 can fit inside the space 45 to enable the bot 25 to move across the track structure 13 on top of storage structure 1 without the underside of the storage container 9 catching on the track structure 13 or another part of the storage structure 1. When the bot 25 has reached its intended destination, the lifting mechanism 33 controls the tethers 35 to lower the container-holding device 37 and the corresponding storage container 9 out of the space 45 and into the intended position. The intended position may be a stack 11 of storage containers 9 or an egress point of the storage structure 1 (or an ingress point of the storage structure 1 if the bot 25 has moved to collect a storage container 9 for storage in the storage structure 1). Although in the illustrated example the upper and lower portions 41, 43 are separated by a physical divider, in other examples, the upper and lower portions 41, 43 may not be physically divided by a specific component or part of the body 27 of the bot 25. The upper and lower configuration of the bot 25 allows the bot 25 to occupy only a single grid cell 14 on the track structure 13 of the storage system 1.

In an alternative example, the container-receiving space 45 of the bot 25 may not be within the body 27 of the bot 25. For example, the container-receiving space 49 may instead be adjacent to the body 27 of the bot 25, e.g. in a cantilever arrangement with the weight of the body 27 of the bot 25 counterbalancing the weight of the container 9 to be lifted. In such embodiments, a frame or arms of the lifting mechanism 33 may protrude horizontally from the body 27 of the bot 25, and the tethers 35 may be arranged at respective locations on the protruding frame/arms and configured to be raised and lowered from those locations to raise and lower a storage container 9 into the container-receiving space 45 adjacent to the body 27. The bot 25 may incorporate the battery retention system 100 described above by providing the battery compartment 150 within the body 27 of the bot 25 such that the battery compartment 150 is externally accessible from above the body 27 of the bot 25 to receive a battery 110 in the downwards direction. Once received in the battery compartment 150, the battery 110 may provide electrical power to one or more electrical or electronic components of the bot 25, such as the lifting mechanism 33 and/or the driving assembly.

FIG. 26 shows the bot 25 of FIG. 25 in which an example region of space 48 demarcated with dotted lines within the upper portion 41 of the bot 25 may be used as the location of the battery compartment 150 (not shown), though other regions within the bot 25 that are externally accessible from above the body 27 of the bot 25 could also be used. The top side 28 of the body 27 of the bot 25 comprises an opening 47 in communication with, or acting as the top opening 156 of the battery compartment 150 so that a battery 110 may be directly lowered into the battery compartment 150 via the opening 47 from a location above the top side 28 of the body 27 of the bot 25, and directly lifted from the battery compartment 150 via the opening 47 to a location above the top side 28 of the body 27 of the bot 25. The retention members 158 of the battery compartment may be mounted on the body 27 of the bot 25, e.g. on the top side 28 of the body 27, or they may be mounted to sidewalls 154 defining the battery compartment 150. As already mentioned above, the battery compartment 150 does not need to be defined by sidewalls 154 and a base 152 within the body 27 of the bot 25. Instead, the battery compartment 150 may simply be a region of space within the body 27 of the bot 25 with appropriately located electrical connectors or contacts for transferring power from the battery 110 to electrical and electronic components of the bot 25. Furthermore, the battery compartment 150 does not need to be fully within the body 27 of the bot 25 and may instead extend through the top of the body 27 of the bot 25 (e.g. via opening 47), or be located fully above the top of the body 27 of the bot 25.

Furthermore, the body 27 of the bot 25 does not need to be defined by the illustrated top panel and side panels and therefore the opening 47 in the top side 28 of the body 27 of the bot 25 does not need to be an opening formed within a panel. Instead, the body 27 of the bot 25 may comprise by a frame structure in which the top of the body 27 is defined by corner portions connected by rods. The space enclosed by the corner portions and rods may be considered the opening 47 in the top side 28 of the body 27.

The use of the battery retention system 100 with the bot 25 helps to keep the battery 110 substantially secure within the battery compartment 150 when the bot 25 is operating on the track structure 13 of the storage structure 1. For example, the retention members 158 help to keep the battery 110 from moving vertically out of the battery compartment 150 during minor bumps or vibrations experienced by the bot 25 during normal operation, or during more serious incidents such as the bot 25 crashing or falling over. By keeping the battery 110 secure within the battery compartment 150 during operation of the bot 25, power interruptions due to the battery 110 disconnecting from the power source compartment 150, or safety hazards due to the battery 110 being ejected from the battery compartment 150 can be minimised.

The storage and retrieval system may comprise one or more robotic arms 50 comprising the end effector 170 described above. The robotic arms 50 may be located on, over, or adjacent to the track structure 13 of the storage structure 1 to allow the battery 110 of a bot 25 to be exchanged while the bot 25 remains on the track structure 13.

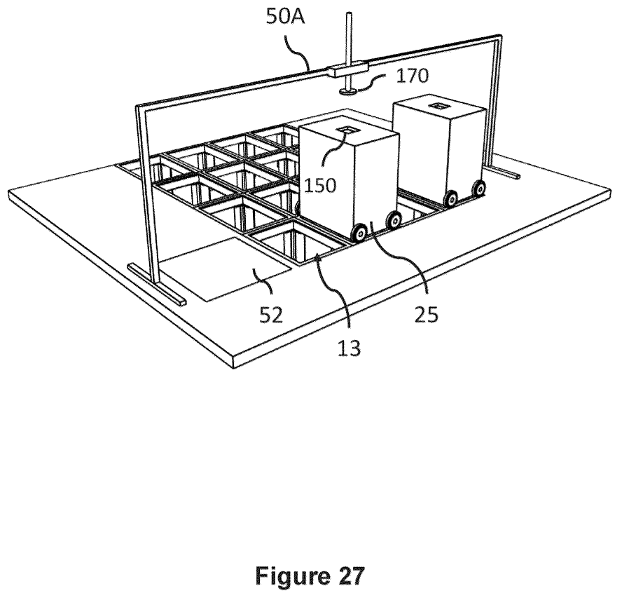

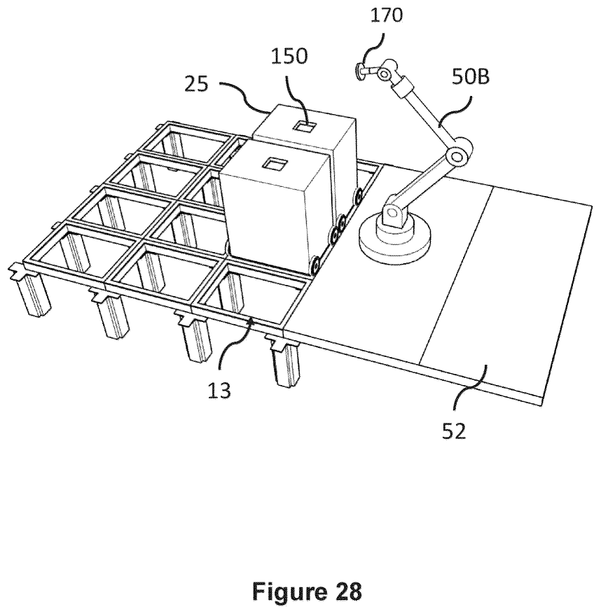

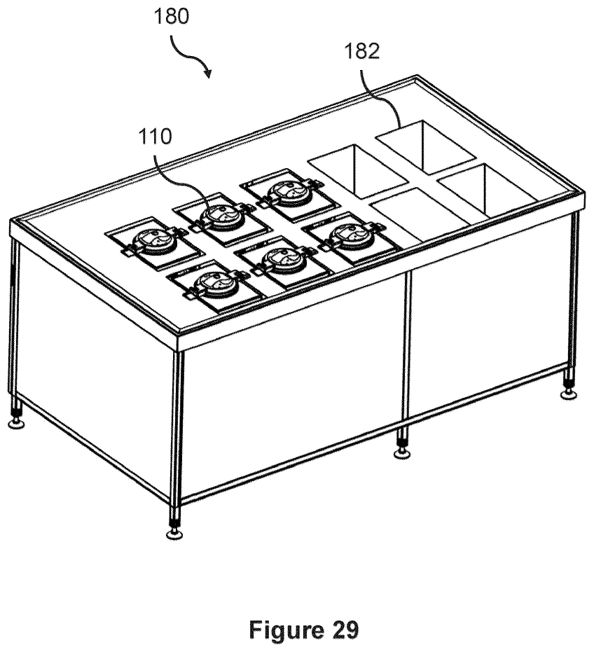

FIG. 27 shows an example of a gantry robot 50A in which the end effector is mounted on a gantry extending over a portion of the track structure 13 such that the end effector can reach the battery compartment 150 of at least one bot 25 on the track structure 13 below. FIG. 28 shows an example of an articulated robot 50B located adjacent to the track structure 13 where it can reach the battery compartment 150 of at least one bot 25 at the edge of the track structure 13. However, the articulated arm 50B could also be located on the track structure 13 itself, e.g. on a grid cell 14.

The storage and retrieval system may further comprise one or more battery stations 180 for storing batteries 110 once they have been removed from a bot 25. FIG. 29 shows an example battery station 180 comprising a plurality of battery station compartments 182 arranged in a horizontal plane. Each battery station compartment 182 is open to a top surface 181 of the battery station to allow each battery station compartment 182 to receive a battery 110 in a downwards direction. The battery station compartments 182 may comprise the same features as the battery compartment 150 of the battery retention system 100, but given that the battery station 180 will typically be stationary in use, the retention members 158 are optional. However, providing the battery station compartments 182 with the retention members 158 may be useful in countries or more specific locations where seismic activity is a risk. The battery station 180 preferably comprises a charging system configured to charge a battery 110 once it has been received in a battery station compartment 182. For example, the battery station compartments 182 may comprise electrical contacts configured to couple to electrical contacts on the battery 110 to deliver power from a power supply to charge the battery 110. Charging systems for charging batteries 110 are well known in the art and will therefore not be described in any further detail.

Each battery storage station 180 may be located in the reachable vicinity of one or more robotic arms 50. For example, a battery station 180 may be located in the region 52 marked in FIG. 28 and FIG. 29. In use, a robotic arm 50 may remove a depleted battery 110 from the battery compartment 150 of a bot 25 and place it into a battery station compartment 182 at the battery station 180 for recharging. The robotic arm 50 may then take a charged battery 110 from a different battery compartment 182 at the battery station 180 and place it into the power source compartment 150 of the bot. In this way, the bot 25 can continue operation with minimal downtime, while the depleted battery 110 is recharged at the battery station 182 where it can be used in a subsequent battery exchange operation.

The present invention thus allows for a mechanically simple system for retaining a battery 110 in a battery compartment 150. By providing a locking member 122 that is rotatable relative to the outer casing 112 of the battery 110, rather than a locking member 122 integrated with the outer casing 112 of the battery 110, the shape of the battery 110 and the battery compartment 150 does not need to allow for relative rotation between the battery 110 and the battery compartment 150 to lock and unlock the battery 110 and therefore more convenient shapes, such as cuboidal shapes, may be chosen.

The invention is not limited to the precise forms described above and various modifications and variations will be apparent to the skilled person without departing from the scope of the invention as defined in the accompanying claims.

For example, the locking member 122 is not limited to having two arms 132. Instead, the locking member 122 could comprise only one arm, or more than two arms arranged symmetrically about the vertical axis, with a corresponding number of retention members 158 arranged symmetrically about the battery-receiving space 155.

The end effector 170 and the locking member 122 are also not limited to having two handling protrusions 174 and two handling recesses 138 respectively. Instead, one or more handling protrusions 174 and handling recesses 138 could be provided, as already shown in FIG. 18, which shows four handling protrusions 174 and four handling recesses 138. The handling portions 174 and the handling recesses 138 could be arranged symmetrically about the rotational axis of the end effector 170 and the locking member 122 respectively. Furthermore, the handling protrusions 174 of the end effector 170 and the handling recesses 138 of the locking member 122 could be swapped around such that the end effector 170 comprises the handling recesses 138 and the locking member 122 comprises the handling protrusions 174. In this case, the orientation of the handling protrusions 174 and the handling recesses 138 would be reversed in the vertical direction.

Although the battery retention system 100 has been described above as having a vertical orientation, wherein the battery compartment 150 receives the battery 110 in a downwards direction, and the locking member 122 and the end effector 170 rotate about a vertical rotational axis V, the battery retention system 100 is not limited to this orientation. In general, the battery compartment 150 is configured to receive the battery 110 in an insertion direction, the locking member 122 is mounted for rotation about a rotational axis parallel to the insertion direction and the end effector 170 is configured to rotate about a rotational axis parallel to the insertion direction. Any directional and orientation terms used in the above description of the battery retention system 100 (e.g. “top”, “bottom”, “upper”, “lower”, “vertical”, “horizontal”, “lift”, “lower”, etc.) are thus not intended to be limiting and should be understood as being with respect to the insertion direction of the battery. For example, the battery retention system 100 (including the battery compartment 150, battery 110, and end effector 170) described above could be rotated 90 degrees to a horizontal orientation such that the battery compartment 150 is configured to receive the battery 110 in a horizontal direction, the rotation axis of the locking member 122 is horizontal, and the end effector is configured to move the battery 110 into and out of the battery compartment 150 in a horizontal direction. Such a battery retention system could also be used with the above-described bot 25. In particular, instead of the battery 110 being moved into and out of the battery compartment 150 from above the bot 25, the battery 110 could be moved into and out of the battery compartment 150 from a lateral side of the bot 25, e.g. via an external opening in the lateral side of the bot 25.

1-26. (canceled)

27. A power source retention system comprising:
a power source including an outer casing and a locking member mounted on top of the outer casing and configured for rotation about a vertical axis relative to the outer casing; and
a power source compartment configured to removably receive the power source into a power-source-receiving space in a vertical direction, the power source compartment including a retention member located adjacent to the power-source-receiving space;
wherein when the power source is in the power-source-receiving space, the locking member is rotatable about the vertical axis in a locking direction to a locked position in which the locking member engages the retention member to block the power source from being upwardly removed from the power source compartment, and the locking member is further rotatable in an opposite, unlocking direction about the vertical axis to an unlocked position in which the locking member is unengaged from the retention member to allow the power source to be upwardly removed from the power source compartment.

28. The power source retention system according to claim 27, wherein the locking member comprises:
an arm protruding horizontally outwards past the outer casing and wherein the retention member is configured to engage the arm when the locking member is rotated to the locked position and disengage from the arm when the locking member is rotated to the unlocked position.

29. The power source retention system according to claim 28, wherein the retention member comprises:
a retention channel configured to receive the arm when the locking member is rotated to the locked position, the retention channel being partially defined by a top retention wall configured to substantially block upward movement of the arm to block the power source from being removed from the power source compartment; and
optionally, wherein the retention channel is further defined by an end retention wall configured to block further rotation of the arm in the locking direction once the locking member is in the locked position.

30. The power source retention system according to claim 29, wherein the top retention wall comprises:
a retention protrusion extending downwardly into the retention channel, wherein the retention protrusion is configured to resist rotation of the locking member in the unlocking direction once the arm is in the locked position, and wherein the retention protrusion is vertically deflectable such that the arm will move past the retention protrusion when a torque applied to the locking member exceeds a torque threshold; and
optionally, wherein the arm includes a depression configured to receive the retaining protrusion when the locking member is in the locked position.

31. The power source retention system according to claim 30, wherein at least a portion of the top retention wall is vertically deflectable such that the retention protrusion is vertically deflectable.

32. The power source retention system according to claim 31, comprising:
a stop wall extending over the top retention wall, the stop wall being vertically spaced from the top retention wall to block vertical deflection of the top retention wall past a threshold deflection.

33. The power source retention system according to claim 27, wherein the locking member is configured to be vertically movable relative to the outer casing between a holding position in which a portion of the locking member is engaged with a portion of the outer casing to prevent rotation of the locking member about the vertical axis relative to the outer casing, and a release position in which said portion of the locking member is disengaged from said portion of the outer casing to allow rotation of the locking member about the vertical axis relative to the outer casing.

34. The power source retention system according to claim 32, wherein the locking member comprises:
an upper portion and a lower portion, the outer casing includes a top wall sandwiched between the upper portion and the lower portion, and the upper portion and the lower portion are rigidly connected together through the top wall; and
wherein the lower portion is configured to engage with the top wall when the locking member is in the holding position and disengage from the top wall when the locking member is in the release position.

35. The power source retention system according to claim 34, wherein a downwards facing surface of the top wall of the outer casing and an opposing, upwards facing surface of the lower portion of the locking member comprise:
interlockable features configured to interlock when the locking member is in the holding position to prevent rotation of the locking member about the vertical axis relative to the outer casing, and disengage when the locking member is in the release position to allow rotation of the locking member about the vertical axis relative to the outer casing.

36. The power source retention system according to claim 35, wherein the interlockable features are circumferentially arranged about the vertical axis and are configured to engage each other in a circumferential direction when the interlockable features are interlocked to prevent rotation of the locking member relative to the outer casing.

37. The power source retention system according to claim 36, wherein the interlockable features comprise:
castellations.

38. The power source retention system according to claim 34, wherein the outer casing comprises:
a mount removably mounted on an external wall of the outer casing and the mount includes the top wall.

39. The power source retention system according to claim 27, wherein the locking member comprises:
a plurality of arms, and the power source compartment comprises:
a plurality of retention members, wherein each retention member is configured to engage a respective arm when the locking member is rotated to the locked position.

40. A power source retention system according to claim 27, in combination with a load handling device for lifting and moving containers arranged in stacks in a storage structure, the storage structure including a track structure, the track structure including a first set of tracks and a second set of tracks, the first set of tracks extending in a first direction and the second set of tracks extending in a second direction, the second direction being substantially perpendicular to the first direction, to form a grid pattern defining a plurality of grid cells above the stacks of containers, the load handling device comprising:
a driving assembly configured to horizontally move the load handling device on the track structure;
a container-holding device configured to releasably hold a container from above;
a lifting mechanism configured to raise and lower the container-holding device; and
the power source retention system, the power source being configured to electrically couple to the power source compartment to power one or more components of the load handling device.

41. The load handling device according to claim 40, wherein the locking member is externally exposed when the power source is within the power source compartment.

42. A power source retention system according to claim 27, in combination with a power source station comprising:
a charging system configured to charge the power source when received in the power source compartment.

43. A power source retention system according to claim 27, in combination with a power source exchange system comprising:
a power source handling device including an end effector configured to releasably engage the locking member, and further configured to rotate about the vertical axis to rotate the locking member between the locked position and the unlocked position and move vertically relative to the power source compartment to lower and raise the power source into and out of the power source compartment.

44. The power source exchange system according to claim 43, wherein the locking member comprises:
a first handling feature, and the end effector comprises:
a second handling feature, wherein the second handling feature is moveable to an engaged position for engaging the first handling feature in both the locking direction and the unlocking direction to allow the end effector to rotate the locking member in both the locking direction and the unlocking direction, and wherein the first and second handling features are configured such that the second handling feature is moveable to the engaged position by first moving in a circumferential direction towards the first handling feature and subsequently moving upwards to the engaged position.

45. The power source exchange system according to claim 43, comprising:
a load handling device for lifting and moving containers arranged in stacks in a storage structure, the storage structure including a track structure, the track structure including a first set of tracks and a second set of tracks, the first set of tracks extending in a first direction and the second set of tracks extending in a second direction, the second direction being substantially perpendicular to the first direction, to form a grid pattern defining a plurality of grid cells above the stacks of containers, the load handling device comprising:
a driving assembly configured to horizontally move the load handling device on the track structure;
a container-holding device configured to releasably hold a container from above;
a lifting mechanism configured to raise and lower the container-holding device; and
the power source retention system;
wherein the power source is configured to electrically couple to the power source compartment to power one or more components of the load handling device.

46. A power source exchange system of claim 45, in combination with a storage and retrieval system comprising:
a storage structure including:
a track structure, the track structure including a first set of tracks and a second set of tracks, the first set of tracks extending in a first direction and the second set of tracks extending in a second direction, the second direction being substantially perpendicular to the first direction, to form a grid pattern defining a plurality of grid cells;
a plurality of upright members supporting the track structure from below to define a storage area below the track structure for storing a plurality of stacks of containers below each grid cell; and/or
a load handling device.
